(19) United States
(12) Patent Application Publication
(10) Pub. No.: US 2011/0226460 A1
(43) Pub. Date: Sep. 22, 2011

(54) THERMAL DESIGN POWER INTEGRATION

(76) Inventor: Sigmund Sommer, Las Vegas, NV (US)

(21) Appl. No.: 12/726,445

(22) Filed: Mar. 18, 2010

(51) Int. Cl. F28F 27/00; H01R 24/00; G06F 1/20

(52) U.S. Cl. 165/200; 439/626; 165/121

(57) ABSTRACT

A heat dissipation device having the ability to communicate heat dissipation information and/or capabilities such as a Thermal Design Power rating.

### FIELD

The present disclosure relates generally to computer heatsinks. More particularly, the present disclosure relates heatsinks that are able to output signals that are indicative of their operational parameters.

### BACKGROUND AND SUMMARY

Interactive Data Corp. (IDC) reported in December 2008 that it expects 2009 worldwide PC sales to be $267 billion. Intel is the global leader in central processing units (CPU). Intel has 82 percent of the Desktop CPU market share. Its nearest rival, Advanced Micro Devices (AMD), has 17.5% of the Desktop CPU market. In comparison, Intel controls 89% of Mobile CPU market and AMD has 10%. These next generation CPU's need to have heat sinks to dissipate heat. There are a plethora of heat sink designs and manufacturers, including Thermaltake, Cooler Master, Zalman, and Thermalright. With the CPU's and other heat generating components producing more heat than ever, retail heat sink sales have reached an all time high.

Heatsink manufacturers have just as many designs for heat dissipation on video cards as they do for CPUs. The heatsink types can range from passive cooling, to forced air using fans, to even liquid cooling. The designs do not stop there. Similar designs have been produced for other chipsets of the motherboard, power supplies, hard disks, even for the RAM modules. With all these components using more power than ever and producing more heat than ever, heatsinks are in high demand for almost every powered component.

According to one aspect of the present disclosure, a heat dissipating device is provided. The device including a memory and a communication port; the memory being dedicated to storing information related to the operation of the heat dissipating device, the memory having first data thereon indicative of the thermal properties of the heat dissipating device; the communication port coupled to the memory to permit communication of the first data to a processing unit.

According to another aspect of the present disclosure, a heatsink is provided including a heat dissipating body; and a memory coupled to the heat dissipating body and dedicated to storing information related to operation of the heatsink.

According to another aspect of the present disclosure, a heat dissipating device is provided. The device including a heat dissipating body; a fan coupled to the heat dissipating body; and a printed circuit board. The printed circuit board including a memory dedicated to storing heat dissipating information; a processor dedicated to performing operations related to heat dissipation; a fan controller; and an output port configured to output heat dissipation information to a motherboard.

According to another aspect of the present disclosure, a device interconnect is provided. The interconnect including first, second, third, and fourth electrically conductive wires; a first terminal coupled to each of the first, second, third, and fourth wires; a second terminal coupled to each of the first, second, third, and fourth wires; each of the first and second terminals including four similarly sized voids therein and a fifth void that is differently sized than the four similarly sized voids, three of the similarly sized voids being located in a row with similar spacing between the first and second voids and the second and third voids, the fourth void being located in a row with the fifth void and in a column with the third void; the fifth void being disposed at least partially within each of the columns of the first and second voids.

Additional features of the present disclosure will become apparent to those skilled in the art upon consideration of the following detailed description of the presently perceived best mode of carrying out the disclosure.

### BRIEF DESCRIPTION OF THE DRAWINGS

The detailed description of the drawings particularly refers to the accompanying figures in which:

FIG. 1 is a perspective view of a cooling system;

FIG. 2 is a top perspective view of a printed circuit board;

FIG. 3 is a bottom perspective view of the printed circuit board of FIG. 2 and a chip interface;

FIG. 4 is a perspective view of a terminal for an end of a wire suitable for interfacing with the printed circuit board of FIG. 2; and

FIG. 5 is a perspective view of a header that is part of the printed circuit board of FIG. 2 and is suitable for receiving the terminal of FIG. 4.

### DETAILED DESCRIPTION OF THE DRAWINGS

Modern processors, including the INTEL Core i7 processor, include multiple independent cores (or CPUs). Multi-core processors can include two cores (dual-core), four cores (quad-core), or more.

Intel has developed what they refer to as “Turbo Boost Technology.” Each processor core is provided with a base operating frequency (speed). Turbo Boost Technology allows processor cores to run faster than the base operating frequency if the processor is operating below rated power, temperature, and current specification limits.

The ratings for the power, temperature, and current are determined by reference to the Thermal Design Power (TDP) of the system. TDP represents the maximum amount of power that a cooling system in a computer is required to dissipate. Accordingly, the ability of a processor core to take advantage of the Turbo Boost Technology is constrained by the determination of TDP and by the power delivery limits derived from the TDP. Thus, TDP provides limits on electrical current consumption of the processor, power consumption of the processor, and the temperature of the processor and these limits govern the availability of Turbo Boost mode.

Currently, TDP of a system is determined by obtaining a rating for the cooling devices, (heatsinks, fans, combinations thereof, or otherwise) employed therein. The manufacturers of the cooling devices rate their devices and assign TDP ratings thereto. These TDP ratings are communicated through manuals, packaging, or otherwise to the assemblers or users of the computers in which they are installed. The assemblers/users input the TDP into the bios of the assembled computers. Then, this value of TDP is used as the computer operates including making decisions to allow cores to assume Turbo Boost mode.

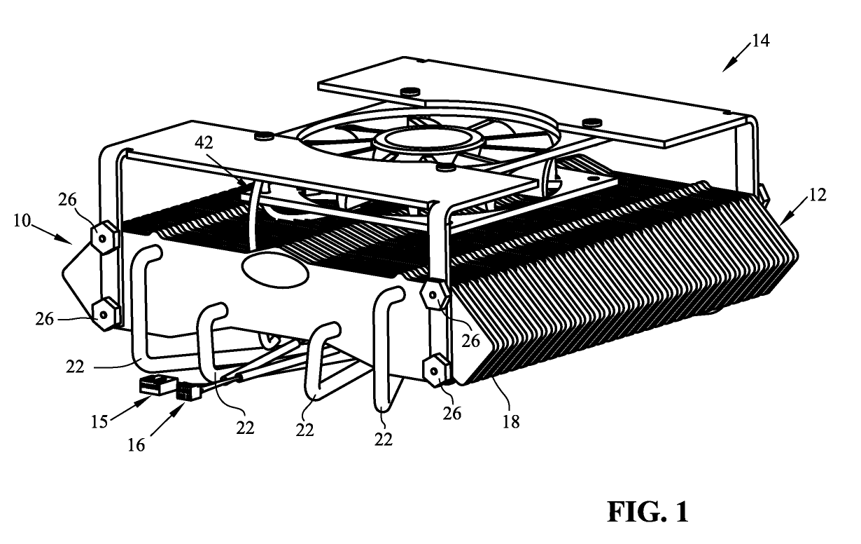

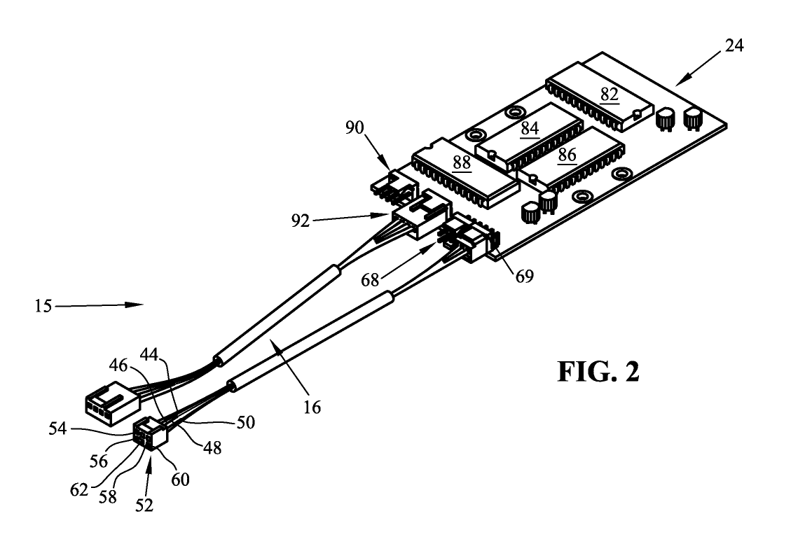

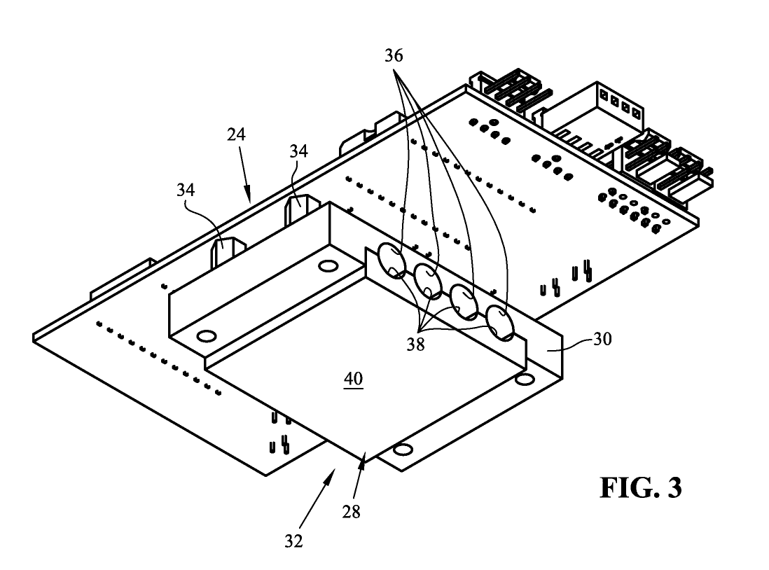

FIG. 1 shows cooling system 10 including heatsink 12, fan 14, 4-pin cable 15, and SmartSink™ cable 16, and printed circuit board (PCB) 24 (FIG. 2). Heatsink 12 includes flanges 18, fan mounts 20, conduction paths 22, and chip interface 28 (FIG. 3).

Heatsink 12 is constructed primarily from Aluminum or similar alloy thereof. However, other sandwiches and alloys of other materials are envisioned. Flanges 18 are provided to give a relatively large amount of surface area to heatsink 12. Increased surface area provides increase heat dissipation from heatsink 12 into the ambient air. Fan mounts 20 are threaded bores that receive bolts 26 that couple fan 14 to heatsink 12. Conduction paths 22 are both external and internal to the main body of heatsink 12. Conduction paths 22 travel from the chip interface surface to various locations within heatsink 12. Conduction paths 22 enhance the heat transfer and dissipation throughout heatsink 12. Chip interface 28 includes aluminum heat spreader 30 and copper heat spreader 32. Aluminum heat spreader 30 includes PCB mounts 34 and a plurality of fluid passage receiving channels 36. PCB mounts 34 are threaded voids defined in aluminum heat spreader 30 sized and shaped to receive bolts therein. Fluid passage receiving channels 36 cooperate with fluid passage receiving channels 38 defined in copper heat spreader 32 to define cylindrical channels that receive conduction paths 22 therein. Copper heat spreader 32 further includes conduction surface 40 sized and located to abut a processor (not shown). This abutment provides for heat conduction from the processor to chip interface 28.

Fan 14 is a heatsink fan of the type typical in the art. Fan 14 mounts to heatsink 12 via bolts 26 and fan mounts 20. Fan 14 also includes cord 42 that electrically couples fan 14 to PCB 24.

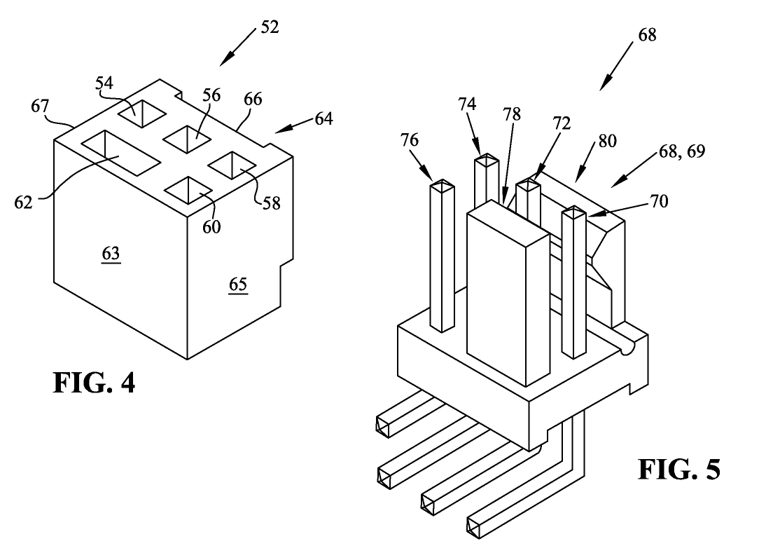

4-pin cable 15 is a common interconnect cable of the type often used for connecting a fan to a motherboard. However, SmartSink™ cable 16 (FIG. 4) is a specifically created cable for transmitting data about heatsink 12 to a motherboard. SmartSink™ cable 16 includes four wires 44, 46, 48, 50 and terminals 52 at each end. Terminals 52 include five voids therein. The five voids include four wire voids 54, 56, 58, 60 and an orienting void 62. Each wire void 54, 56, 58, 60 is similarly sized and receives one wire 44, 46, 48, 50 therein. Orienting void 62 is differently shaped than wire voids 54, 56, 58, 60. Wire voids 54, 56, 58 are arranged in an upper row while wire void 60 and orienting void 62 are arranged in a lower row. Additionally, upper edges 64 of terminals 52 include retainer area 66. Terminals 52 are sized and shaped to be received by headers 68 shown in FIG. 5. Terminals 52 are 6.09 mm tall by 7.66 mm wide. Wire voids 54, 56, 58, 60 each measure 1.35 mm square. Retainer area 66 is 0.35 mm high by 5.08 mm wide. Wire voids 54, 56, 58 are positioned such that their upper edges are 1.59 mm down from the upper-most edge 64 of terminals 52. Additionally, there is a ______ mm spacing between voids 54 and 56 as well as between voids 56 and 58. Orienting void 62 is 3.18 mm wide by 1.28 mm high. Both wire void 60 and orienting void 62 are located such that their lower edges are 0.62 mm up from the lower-most edge 63 of terminals 52. Wire void 60 is directly below wire void 58 and offset from the right side 65 of terminal 52 by 0.62 mm. Orienting void 62 is offset from the left side 67 of terminal 52 by _____ mm. Each of Wire voids 54, 56, 58, 60 and orienting void 62 are sized and positioned to securely interconnect with headers 68, 69 of PCB 24.

PCB 24 couples to aluminum heat spreader 30 via screws and includes Analog to Digital integrated circuit (A/D IC) 82, flash memory 84, fan driver integrated circuit 86, EEprom 88, two 4-pin fan headers 90, 92, and two SmartSink headers 68, 69.

A/D IC 82 is a standard A/D IC that is known in the art. A/D IC 82 is able to convert analog signals, such as temperature readings and fan speed readings, into digital form that is usable by other IC's. Flash memory 84 is standard non-volatile computer memory that can be electrically erased and reprogrammed. Fan driver IC 86 contains logic that provides for the controlling of the speed of fan 14. EEprom 88 stores custom TDP programs and BIOS communications thereon. EEprom 88 is thus able to act as a limited function processor and also act as a memory device. 4-pin fan header 90 is an I/O port for connecting to fan 14. 4-pin header 92 is an I/O port for connecting to a motherboard (not shown). SmartSink header 68 is an I/O port for connecting to a PCB of another SmartSink device (not pictured) such that multiple SmartSink devices can be daisy-chained. SmartSink header 69 is an I/O port for connecting to the motherboard.

Header 68, 69 includes four pins 70, 72, 74, 76, alignment lug 78, and retainer 80. Pins 70, 72, 74, 76 are electrically coupled to PCB 24. Alignment lug 78 is non-conductive and serves to require that terminals 52 can only engage headers 68 in a proper fashion and to require that cables other than SmartSink cable 16 are unable to connect thereto. Retainer 80 is a somewhat pliable extension that engages retainer area 66 of terminals 52 to hold terminals 52 in engagement with headers 68.

As previously noted, EEprom 88 stores custom TDP programs thereon. EEprom 88 includes TDP values for cooling system 10 to which it is attached. By connecting PCB 24 to the motherboard, cooling system 10 is able to talk to the motherboard and communicate its TDP values thereto. Accordingly, a BIOS program can receive this information directly from cooling system 10 rather than requiring a user to input the TDP information. Additionally, the custom TDP programs on EEprom 88 can derive TDP for cooling system 10 as a function of a number of inputs rather than as a fixed number. The TDP function considers factors such as existing temperature of heatsink 12, ambient temperature, and speed of fan 14.

By knowing the TDP of heatsink 12, including a dynamically rendered TDP reflective of current conditions, the motherboard is able to determine the propriety of various actions, including use of Turbo Boost Technology, that are dependent upon the TDP of the system. Additionally, header 69 allows multiple SmartSink devices to communicate with each other. As previously noted, such other devices can be other CPU heatsinks, graphics processing unit (GPU) heatsinks or other cooling devices. One embodiment of TDP function considers the operation of the worst performing heatsink and uses that heatsink as the basis for the overall TDP performance. In another embodiment, the programming is sophisticated enough to note different TDP for different heatsinks and then allow different operating profiles for each processor associated with the various heatsinks. Also, when rating a heatsink, current manufacturers typically assign a TDP rating to their heatsinks that is below the TDP that is realized by that heatsink when that heatsink is operating at its peak. Such reduction in heatsink values can account for conditions, such as dust collection or fan degradation, so that the heatsink can continue to operate in a degraded mode and still perform according to the TDP rating that is assigned without causing CPU damage. Accordingly, traditional TDP ratings often fail to take full advantage of the cooling properties of the heatsinks.

Embodiments are envisioned for use with multiple CPU's on a single motherboard. Embodiments are envisioned for use with Scalable Link Interface (SLI), a technology developed by Nvidia Corporation to allow a system to run up to 4 GPU's on one machine. Similarly, embodiments are envisioned for use with Crossfire, a technology developed by ATI that also allows up to 4 GPU's on one machine. Embodiments are envisioned allowing for use with multiple video cards.

It should be appreciated that cooling system 10 is envisioned for use with all types of heat producing elements including video card chips, chipsets resident on motherboards or the like, power supplies, hard disks, and RAM modules. Such usage would allow further performance to be extracted therefrom and provide reduced risk of heat related failure. Additionally, embodiments are envisioned where SmartSink technology is integrated into forced air systems, liquid cooled systems, and noise cancellation refrigeration systems.

In still yet another application, the SmartSink technology can be used to detect the actual heat dissipation performance of a particular heat sink such as because of dust accumulation or otherwise. In certain applications with multiple GPU's, each GPU needs to run at the same speed as the others. Smartsink can lower the TDP rating on the underperforming heat sink and thereby mandate a degraded mode and lower GPU speed for all GPU's. This would prevent the chip being cooled by the dusty heatsink from failing due to insufficient cooling while running at a speed that is ideal for the other GPU's but too fast for the chip with the dusty heatsink. In such cases, a report can be generated for the user indicating that the GPU's are being underclocked and identify which heatsink is clogged and the source of the need for the performance degredation. Furthermore, if the state of computing changes such that multiple GPU's are allowed to operate at differing speed, the degraded mode can be isolated to only the GPU with the dusty heatsink. In such a case, a report would still be generated informing the user of the degraded mode of operation being executed.

Although the disclosure has been described in detail with reference to certain preferred embodiments, variations and modifications exist within the spirit and scope of the disclosure as described and defined in the following claims.

1. A heat dissipating device including:
a memory; the memory being dedicated to storing information related to the operation of the heat dissipating device, the memory having first data thereon indicative of the thermal properties of the heat dissipating device; and
a communication port; the communication port coupled to the memory to permit communication of the first data to a processing unit.

2. The device of claim 1, wherein the first data includes instructions that consider current operating parameters of the heat dissipating device and generate data indicative of the heat dissipating capacity of the heat dissipating device.

3. The device of claim 2, wherein the instructions generate a Thermal Design Power rating.

4. The device of claim 1, wherein the first information includes a Thermal Design Power rating determined by a manufacturer.

5. The device of claim 1, wherein the communication port is sized and shaped to receive a wire therein that is in communication with a processor to allow communication of thermal data to the processor.

6. A heatsink including:
a heat dissipating body; and
a memory coupled to the heat dissipating body and dedicated to storing information related to operation of the heatsink.

7. The heatsink of claim 6, further including a printed circuit board that receives and electrically couples to the memory.

8. The heatsink of claim 7, wherein the printed circuit board includes a fan interface thereon.

9. The heatsink of claim 7, wherein the printed circuit board includes a data interface that is electrically coupled to the memory and is configured to output heatsink operation data.

10. The heatsink of claim 6, wherein the memory includes instructions thereon that, when interpreted by a processor, generate information about the operation of the heatsink.

11. The heatsink of claim 10, wherein the processor is a limited function processor that is dedicated to processing data related to heat dissipating elements.

12. A heat dissipating device including:
a heat dissipating body;
a fan coupled to the heat dissipating body; and
a printed circuit board, including:
a memory dedicated to storing heat dissipating information;
a processor dedicated to performing operations related to heat dissipation;
a fan controller; and
an output port configured to output heat dissipation information to a motherboard.

13. The device of claim 12, wherein the printed circuit board further includes a temperature sensor.

14. The device of claim 12, wherein the processor is an eeprom.

15. The device of claim 14, wherein the eeprom stores instructions thereon that, when executed, provide a current Thermal Design Power rating to the output port.

16. The device of claim 12, further including a fan control port.

17. The device of claim 12, wherein the printed circuit board further includes an input port configured to receive heat dissipation information from a second heat dissipation device.

18. A device interconnect including:
first, second, third, and fourth electrically conductive wires;
a first terminal coupled to each of the first, second, third, and fourth wires;
a second terminal coupled to each of the first, second, third, and fourth wires;
each of the first and second terminals including four similarly sized voids therein and a fifth void that is differently sized than the four similarly sized voids, three of the similarly sized voids being located in a row with similar spacing between the first and second voids and the second and third voids, the fourth void being located in a row with the fifth void and in a column with the third void; the fifth void being disposed at least partially within each of the columns of the first and second voids.
